(19) United States
(12) Patent Application Publication
(10) Pub. No.: US 2023/0110470 A1
(43) Pub. Date: Apr. 13, 2023

(54) Sorbent-based oxygen separation

(71) Applicants: Ellen B. Stechel, Albuquerque, NM (US); Ivan Ermanoski, Tempe, AZ (US); Shuguang Deng, Mesa, AZ (US); Mai Xu, Piscataway, NJ (US)

(72) Inventors: Ellen B. Stechel, Albuquerque, NM (US); Ivan Ermanoski, Tempe, AZ (US); Shuguang Deng, Mesa, AZ (US); Mai Xu, Piscataway, NJ (US)

(21) Appl. No.: 17/901,537

(22) Filed: Sep. 1, 2022

Related U.S. Application Data
(60) Provisional application No. 63/240,685, filed on Sep. 3, 2021.

(51) Int. Cl. B01D 53/04; B01J 20/04; B01J 20/02

(52) U.S. Cl. CPC B01D 53/0462; B01J 20/04; B01J 20/0207; B01D 2253/112; B01D 2256/10; B01D 2257/104; B01D 2259/45; B01D 2259/40009; B01D 2259/40056; B01D 2259/40081

(57) ABSTRACT

Separating oxygen from a gas includes contacting an oxygen-selective sorbent with a gas stream, adsorbing oxygen in the gas stream with the sorbent, heating the sorbent to greater than 400° C., and desorbing a majority of the oxygen. The sorbent is selective for oxygen, and adsorbing occurs at a temperature between 275-325° C. An oxygen separation system includes a sorption bed, a heater configured to heat the sorption bed, an oxygen analyzer, a first conduit configured provide an input gas to the sorption bed, a second conduit configured to provide processed input gas from the sorption bed to the oxygen analyzer, a third conduit configured to provide a purge gas to the sorption bed, and a fourth conduit configured to provide processed purge gas to the oxygen analyzer. The first and third conduits are configured to flow the input gas and the purge gas flow in opposite directions through the sorption bed.

### CROSS REFERENCE TO RELATED APPLICATION

This application claims the benefit of U.S. Pat. Application 63/240,685 filed on Sep. 3, 2021, which is incorporated herein by reference in its entirety.

### STATEMENT OF GOVERNMENT INTEREST

This invention was made with government support under DE-EE0008991 awarded by the Department of Energy. The government has certain rights in the invention.

### TECHNICAL FIELD

This invention relates to systems and methods for separation of oxygen from a gas mixture.

### BACKGROUND

Production of renewable energy can address increasing energy demand and global climate concerns. One suitable technology is the concentration and storage of solar power (CSP) for generating electricity. Thermal energy from the sun can be stored as chemical energy in a process called solar thermochemical energy storage (TCES). TCES can be used to store energy while the system is capturing solar radiation, and release energy at other times for continuous power generation. TCES uses reversible chemical reactions for these store-and-release energy cycles. Reversible redox reactions involving oxygen gas constitute one class of these TCES reactions.

### SUMMARY

This disclosure describes systems and methods for a temperature swing adsorption (TSA) process in which oxygen is captured from a gas mixture to produce substantially inert gas streams with low pO2 during the sorption step of the process. The sorbents can then be regenerated at a higher temperature. The TSA process includes adsorption, heating, counter-current desorption, and cooling. The oxygen separation is achieved using an oxygen selective sorbent, such as YBaCo₄O_{7+δ} (YBC114, where oxygen non-stoichiometry (δ) represents the amount of oxygen adsorbed).

YBC114 is capable of capturing O₂ within a narrow temperature range from 275° C. to 325° C. and desorbing most of O₂ at a temperature higher than 400° C. These sorption and regeneration temperatures are both lower than other TCES materials such as perovskites or redox metal oxides. YBC114 also shows consistent sorption and desorption performance during cycles and is thus suitable for temperature swing adsorption TCES processes.

Oxygen can be removed from the TCES reactor as it is released, thereby decreasing the oxygen partial pressure (pO2) and increasing the reduction capacity of the redox material to a sufficient extent at an acceptable temperature. Oxygen removal is achieved by purging the reactor with an inert sweep gas (ISG). Oxygen separation is characterized by relatively low cost, flexible operation, and efficient regeneration. Oxygen can then be separated from the sweep gas (typically a mixture containing N₂ and O₂) with an oxygen-selective sorbent. The sorption and desorption (regeneration) can be operated in a cyclic manner with a multiple bed configuration, so that the desired oxygen-depleted product is substantially continuous.

In a first general aspect, an oxygen separation method includes a) contacting a sorbent with a first gas stream and b) adsorbing oxygen in the first gas stream with the sorbent. The sorbent is selective for oxygen and the adsorbing occurs at an adsorbing temperature between 275° C. and 325° C. The first general aspect further includes c) heating the sorbent to a desorbing temperature greater than 400° C., and d) desorbing a majority of the oxygen to yield a second gas stream. A difference between the desorbing temperature and the adsorbing temperature is less than 400° C.

Implementation of the first general aspect can include one or more of the following features.

Some implementations further include cooling the sorbent to a temperature between 275° C. and 325° C. after desorbing the majority of the oxygen. Some cases further include repeating a) through d) after cooling the sorbent. In some cases, contacting the sorbent with the first gas stream includes flowing the first gas stream in a first direction through the sorbent. In some implementations, desorbing the majority of oxygen includes subjecting the sorbent to a vacuum. In some implementations, desorbing the majority of oxygen includes contacting the sorbent with a purge gas. The purge gas can include carbon dioxide, steam, or flue gas. In some cases, the flue gas is recycled flue gas. In some implementations, desorbing the majority of the oxygen includes flowing the purge gas in a second direction through the sorbent. In some cases, the second direction is opposite the first direction. In some implementations, desorbing the majority of the oxygen includes regenerating the sorbent. Certain implementations further include providing the second gas stream to an energy storage reactor. In some cases, adsorbing oxygen in the first gas stream further includes increasing or decreasing a pressure of the first gas stream. Some implementations further include contacting an additional sorbent with an additional gas stream during b), c), or d).

In a second general aspect, an oxygen separation system includes a sorption bed including a sorbent. The sorbent is oxygen-selective. The second general aspect further includes a heater configured to heat the sorption bed, an oxygen analyzer, a first conduit configured provide an input gas to a sorption bed, a second conduit configured to provide processed input gas from the sorption bed to the oxygen analyzer, a third conduit configured to provide a purge gas to the sorption bed, and a fourth conduit configured to provide processed purge gas to the oxygen analyzer. The first conduit and the third conduit are configured to flow the input gas and the purge gas flow in opposite directions through the sorption bed.

Implementations of the second general aspect can include one or more of the following features.

In some cases, the sorption bed further includes an inert packing material. In certain implementations, a particle size of the inert packing material exceeds a particle size of the sorbent. In some implementations, the sorbent includes YBaCo₄O_{7+δ}. In certain cases, the sorption bed is a fixed bed. Some implementations further include an additional sorption bed configured to operate in parallel to the sorption bed. In some cases, an energy storage reactor can include the second general aspect.

The disclosed methods and systems provide multiple advantages related to energy and cost, performance, operation, versatility, and safety. In particular, the disclosed methods and systems provide an economical and efficient option to create and maintain a low pO2 during the thermal reduction step and reduce the overall energy cost for energy storage. Other advantages include the cost effectiveness of the fixed bed system and materials of resources for regeneration of the sorbent, and relatively low sorption temperature. In addition, oxygen sorption selectivity exceeds that of over other gas components, owing at least in part to the oxygen storage properties of the sorbent material. Oxygen can be separated effectively even with an incoming mixture with low oxygen concentration. The desired low pO2 can be reached quickly, and the production of inert sweep gas can be continuous with a multiple bed configuration. Oxygen separation performance is consistent during TSA cycles. The TSA process can be automatically operated with electrical or pneumatic valves, and the temperature and gas flow rate can be remotely controlled with a commercially available platform. The separation unit can be used with various sorbents or for other fixed bed sorption processes. The process has a comparatively low operating temperature for a TSA process, the gases are at near ambient pressure, and the overall risk of the oxygen separation system is low.

### BRIEF DESCRIPTION OF DRAWINGS

FIG. 1 is a schematic diagram of an oxygen separation system.

FIG. 2 is a process flow diagram of an oxygen separation system design.

FIGS. 3A and 3B show temperature profiles during heating and cooling, respectively, of a sorption bed.

FIG. 4 shows experimental and simulated sorption isotherms of YBaCo₄O_{7+δ}.

FIG. 5 shows oxygen uptake isotherms of YBaCo₄O_{7+δ} at 275° C. and 400° C.

FIG. 6 shows temperature swing oxygen uptake-release cycles.

FIG. 7 illustrates the pressure drop of the sorption column with two packing methods.

FIG. 8 shows experimental and simulated oxygen sorption breakthrough curves.

FIG. 9 illustrates desorption profiles of YBaCo₄O_{7+δ} at varying desorption temperatures.

FIG. 10 shows experimental and simulated oxygen concentration profile during TSA cycles at sorption temperature of 300° C.

FIG. 11 shows the simulated TSA profile operated between 300° C. and 500° C. with 1% oxygen.

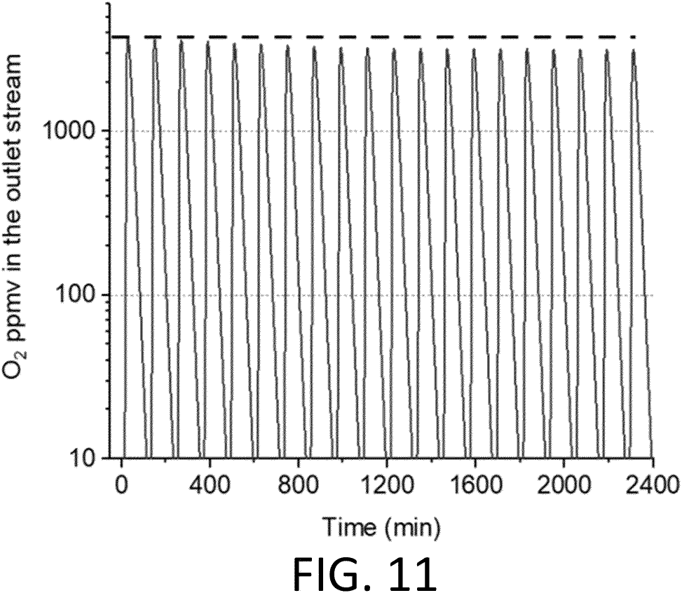

### DETAILED DESCRIPTION

This disclosure describes systems and methods for a temperature swing adsorption (TSA) process in which oxygen is captured from a gas mixture to produce substantially inert gas streams with low pO2 during the sorption step of the process. The sorbents can then be regenerated at a higher temperature. The TSA process includes adsorption, heating, counter-current desorption, and cooling. The process can be carried out in a sorption system with one or more sorption units. For a system containing a single sorption unit, the sorption step can be intermittently or periodically stopped to permit regeneration of the sorbent bed. When multiple sorption units are employed in parallel, one unit can be in sorption operation while other units are undergoing heating, desorption, or cooling. In some embodiments, adsorption cycles are repeatedly carried out in a manner such that production of the desired oxygen-depleted product is substantially continuous.

An example of a suitable sorbent is YBaCo₄O_{7+δ} (YBC 114, where oxygen non-stoichiometry (δ) represents the amount of oxygen adsorbed), an oxygen ion conductor. Due at least in part to its crystal structure and the changeable valence of its Co ions, the material is capable of capturing oxygen within a narrow temperature range from 275° C. to 325° C. and desorbing most of the oxygen at a temperature higher than 400° C. For a TSA operation between 275° C. and 400° C., at a pO2 of 21 kPa, the working capacity of YBC114 is 0.45 mol O₂/mol YBC114. The sorbent material also shows consistent sorption and desorption performance during cycles, thus advantageous for the TSA process.

The oxygen separation system includes one or multiple sorption units depending on the design, one or multiple heaters for controlling the temperature of the sorption unit(s), measurement devices for monitoring or controlling the pressure, temperature, and gas flow rates at the inlets or outlets of the sorption unit(s), and pneumatic valves for automatic operation of the process. The input of the sorption unit(s) connects to the reduction sweep gas coming from the energy storage reactor. During the sorption step, the input gas mixture flows through the sorption bed for oxygen sorption. The resulting processed input gas exits the sorption bed as an inert gas stream. For desorption, the sorption bed can be regenerated at a higher temperature with a counter-current purge flow. The oxygen concentration of the product inert gas can be monitored by an oxygen analyzer.

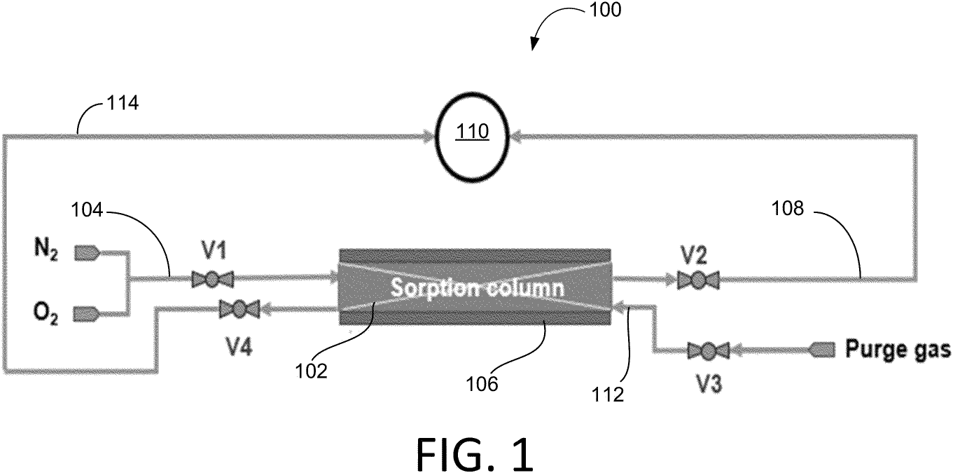

A schematic of an oxygen separation system 100 is shown in FIG. 1. A sorption column 102 includes a sorption bed that is packed with an oxygen-selective sorbent (e.g., YBaCo₄O_{7+δ}) and an inert packing material. The sorption bed can be a fixed sorption bed. Gas connections in the apparatus allow counter-current gas flows for sorption and desorption. During the sorption step, an inert gas (e.g., N₂) and O₂ are mixed to form an input gas in a first gas stream by opening V 1and V2. The first gas stream is provided to the sorption column 102 through a first conduit 104 and contacts the sorbent in the sorbent bed, which absorbs oxygen from the first gas stream. The adsorption occurs at an adsorbing temperature controlled by heater 106 (e.g., a tube furnace). The temperature at which the oxygen is adsorbed is between 275° C. and 325° C. The processed input gas flows from the sorption bed in the sorption column 102 through a second conduit 108 to an oxygen analyzer 110. For the desorption step, the temperature of the sorbent is increased to the desorbing temperature by the heater 106. A temperature difference between the adsorbing and desorbing temperatures is typically less than 400° C. A counter-current flow of purge gas is provided to the sorption column 102 through a third conduit 112 by opening V3 and V4. The first conduit 104 and the third conduit 112 are configured to flow the input gas and the purge gas in opposite directions through the sorption bed. A majority of the adsorbed oxygen in the sorption bed is desorbed and mixed with the purge gas to yield the processed purge gas in a second gas stream. The oxygen concentration of the second gas stream is 100 parts per million volume (ppmv) or less. The processed purge gas in the second gas stream is provided to the oxygen analyzer 108 through a fourth conduit 114. After the sorbent bed is heated to the desorbing temperature and the oxygen has been desorbed, the sorbent can be cooled to a temperature between 275° C. and 325° C. The sorption and desorption steps can be repeated.

The equation below shows the reaction for sorption and desorption of O₂ on YBC114:

$$Y B a C {o}_{4} {O}_{7} + \frac{δ}{2} {O}_{2} ↔ Y B a C {o}_{4} {O}_{7 + 5}$$

The four-step temperature swing absorption (TSA) process includes adsorption, heating, counter-current desorption, and cooling. The TSA process can be carried out in a sorption system containing multiple sorption units in parallel, where one unit can be in sorption operation while other units are undergoing heating, desorption, or cooling. The adsorption cycles are repeatedly carried out in a manner such that the production of the desired oxygen-depleted product is substantially continuous.

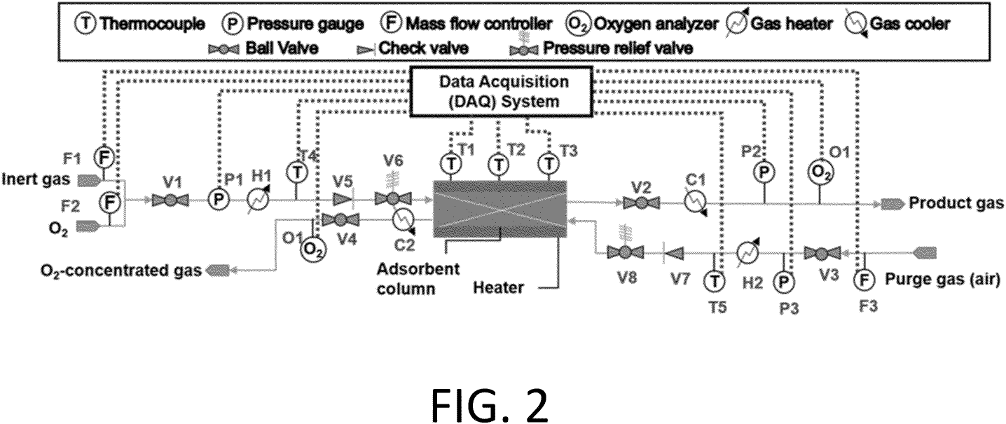

A process flow diagram (PFD) of the oxygen separation design is shown in FIG. 2. The input end of the sorption column is coupled to oxygen and inert gas, which mixes to mimic the reduction sweep gas coming out from TCES. The input gas flows through the sorption column for oxygen sorption and produces an ISG with low pO2. An inline gas heater is included to heat the feeding stream before entering the sorption column, and a cooler is included to cool down the outlet stream for the protection of measurement components. For desorption, the sorbent material regenerates with a purge gas at a higher temperature and is ready for sorption again. The temperatures of the sorbents can be repeatedly changed for sorption-desorption cycles, which is a TSA operation.

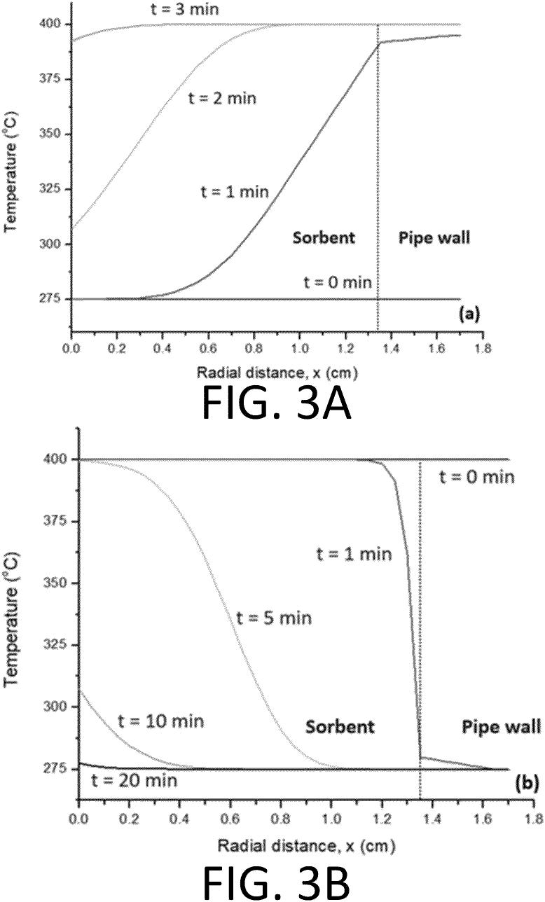

The properties used for the adsorber design calculation include sorbent densities, void fractions, sorption isotherms, kinetics, and fixed bed dynamics. Since the system will be operated in TSA mode, heat transfer modeling was used to optimize the column dimensions to minimize the thermal resistance from the heating source to the sorbent material. A 1-D transient heat transfer calculation can be performed on the radial direction of the sorption bed. The modeling equation is shown as follows:

$$\frac{d T}{d t} = \frac{k}{c ρ} \left(\frac{{\partial }^{2} T}{\partial {x}^{2}}\right)$$

Where T is temperature, t is time, k is thermal conductivity, c is heat capacity, p is density, and x is the radial distance from the center of the pipe. FIG. 3 shows the transient temperature profiles during the heating and cooling steps of a TSA cycle. The sorption and desorption temperatures were assumed to be 275° C. and 400° C. Thermal resistance lies in the sorbent layer at least because the temperature difference in the pipe wall layer is insignificant. The overall sorption system can complete heating within 3 minutes, and cooling within 20 minutes.

In one example, a TSA process was conducted in a single-bed lab oxygen separation system with the following parameters. The sorption column had an internal diameter of 0.85 inches and a length of 24 inches. The column was packed with 40 g of YBC114 and 160 g of inert packing material (silica beads) to increase the average particle size and reduce the column pressure drop. The sorption step was carried out at a temperature of 300° C., and the regeneration was carried out at a temperature of 500° C. The input gas was a gas mixture with 10% oxygen and 90% nitrogen to mimic the reduction sweep gas. The flow rate of the gas mixture into the system was 200 ml/min (STP). The TSA cycle consisted of 20 min sorption, 20 min heating, 40 min desorption, and 40 min cooling. The oxygen concentration of the processed input gas was lower than 100 ppmv (equal to a pO2 of 10 Pa if the total pressure is 1 bar) without an obvious increase during the whole sorption step, and the performance was consistent during cycles.

Implementations of the oxygen separation system include providing an inert sweep gas with low pO2 for thermal reduction in TCES reactors, and production of oxygen-free inert gas (product of sorption) or oxygen-concentrated gas (product of desorption) for use in industrial or agricultural applications. Since the process is operated at relatively high temperatures, the oxygen-concentrated gas can be produced with a sweep gas like CO2 and/or steam for gasification systems or recycled flue gas for oxy-combustion systems. When the oxygen sorption capacity of the sorption material varies with pO2, a pressure swing adsorption (PSA) or a vacuum swing adsorption (VSA) can also be applied to the separation unit to increase or decrease the pressure of the input gas, respectively. Pure oxygen can be produced using a vacuum instead of a sweep gas during the desorption step of the process.

### EXAMPLES

The oxygen separation system is illustrated in detail by the following examples. Unless otherwise indicated, parts and percentages are on a volume basis.

The YBC114 sample was synthesized with an EDTAsol-gel method. Stoichiometric amounts of Y₂O3 (Alfa Aesar, 99.995%), Ba(NO₃)₂ (Acros Organics, 99+%), Co(NO₃)₂ 6H₂O (Sigma-Aldrich, 99+%) were mixed and dissolved in excess HNO₃ solution (Acros Organics, 68-70%), followed by the addition of EDTA (Honeywell, 99+%). The molar ratio of EDTA and all the metal ions (M+) is 1.5:1. The solution was then neutralized with NH₃H₂O (Thomas Scientific, 28% in water) until the pH of the solution was about 8. The solution was dried on a heating plate with stirring until it self-burned to fluffy ashes. The ashes were transferred to a muffle furnace and calcined at 1000° C. in air for 10 hours. After sintering, the resulting samples were cooled back to room temperature rapidly and milled. A thermogravimetric analyzer (TGA, Netzsch TG 209 F1 Libra) was used to investigate the oxygen uptake and release characteristics. The mass of the sample for each measurement was 20-50 mg. All the samples were fully reduced at 400° C. in 20 ml/min nitrogen flow for 2 hours before the measurements. The measurements were performed in a mixed gas flow of oxygen (Matheson, UHP) and nitrogen (Matheson, UHP). The pO2 was controlled by adjusting the ratio of oxygen and nitrogen in the mixed gas flow.

A thermogravimetric analyzer (TGA, Netzsch TG 209 F1 Libra) was used to investigate the oxygen uptake and release characteristics. The mass of the sample for each measurement was 20-50 mg. All the samples were fully reduced at 400° C. in 20 ml/min nitrogen flow for 2 hours before the measurements. The measurements were performed in a mixed gas flow of oxygen (Matheson, UHP) and nitrogen (Matheson, UHP). The pO2 was controlled by adjusting the ratio of oxygen and nitrogen in the mixed gas flow.

The oxygen separation system shown in FIG. 1 was used for TSA operation. A sorption column packed with 20 g of YBC1 14 and 180 g of inert packing material (silica grain) was prepared. The temperatures during sorption and desorption were controlled by a tube furnace (Thermo Scientific Lindberg/Blue M). The oxygen concentration of the outlet stream for both sorption and desorption was measured and recorded by an oxygen analyzer (All GPR-1500 GB) with multiple ranges from 0-10 ppmv to 0-25% for flexible measurements.

The sorption bed was first regenerated with N₂ for 24 hours to remove the initial adsorbed O₂ content in the particles. The TSA cycles, including sorption, heating, desorption, and cooling, were initiated. For the sorption step, V1 and V2 were opened, and a mixture of N₂ and O₂ was fed to the sorption bed. For the heating step, V2 was opened, and the sorption bed was heated to the desired desorption temperature For the desorption step, V3 and V4 were opened and sorbent was regenerated by purging in the counter-current direction. For the cooling step, V4 was opened and the sorbent bed was cooled to the desired sorption temperature.

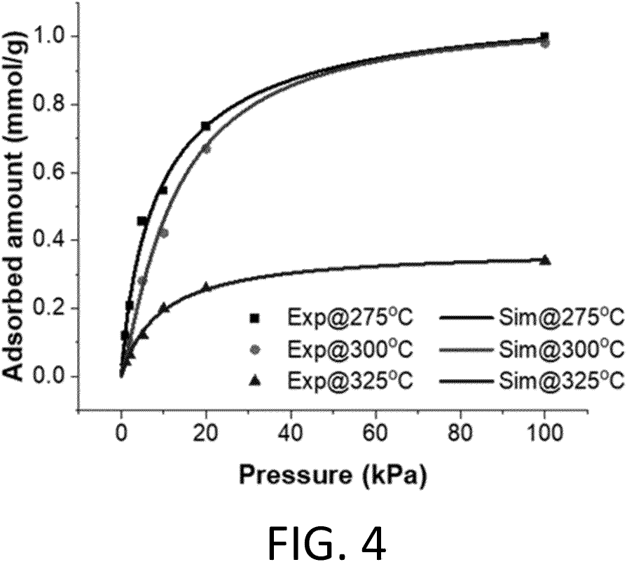

The baseline sorbent material used in the oxygen separation process was YBC114. To assess the oxygen sorption isotherms of YBC114 at different temperatures, the isotherm measurements were conducted at various pO2s with TGA at 275° C., 300° C., and 325° C. A Langmuir-like isotherm model was developed (Sips model) to fit the experimental isotherm data for future process simulation. The equation of the isotherm model is shown as follows:

$$q = {q}_{\text{sat}} \frac{b {p}_{0 \text{z}} {}^{n}}{1 + b {p}_{0 \text{z}} {}^{n}}$$

where q is the uptake amount, qₛₐₜ is the saturation uptake amount, and b and n are isotherm constants. Values of qₛₐₜ, b, and n are determined with a non-linear regression model based on the experimental isotherm data at different temperatures and summarized in Table 1. The experimental and simulated isotherm curves are compared in FIG. 4. The sips model fits the experimental isotherm data, even for the low pO2 range. Overall, YBC114 showed the highest oxygen sorption capacities at 275° C., also close to 300° C. when pO2 approached 100 kPa.

TABLE 1

Sips model parameters for oxygen sorption on YBC114

| | | | |
|---|---|---|---|
| T (°C) | 275 | 300 | 325 |
| q_{Sat}(mmol/g) | 1.12 | 1.07 | 0.38 |
| b (kPa⁻¹¹) | 0.142 | 0.047 | 0.110 |
| n | 0.87 | 1.20 | 0.99 |

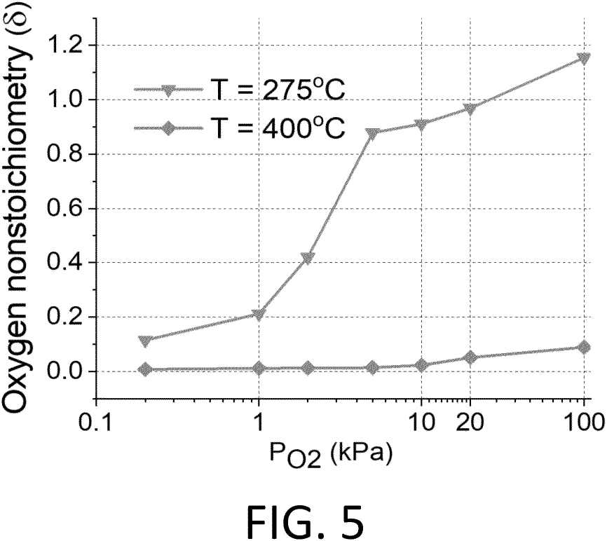

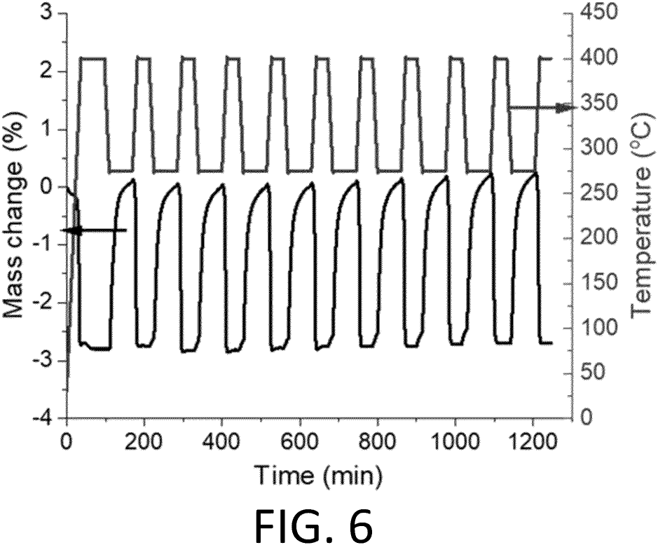

To determine the working capacities in the TSA process, the isotherm measurement was repeated at 400° C. (potential desorption temperature) and compared with the isotherm profile at 275° C., as shown in FIG. 5. The oxygen non-stoichiometry (δ) represents the amount the oxygen adsorbed, which is the number of additional oxygen atoms per unit cell of YBC114. The working capacity between 275° C. and 400° C., at a pO2 of 21 kPa, is 0.45 mol O₂/mol YBC114 (δ= 0.9). FIG. 6 shows the temperature and mass change profiles of TSA cycles between 275° C. and 400° C. tested from TGA. YBC114 showed little or no performance loss from cycle to cycle regarding the oxygen sorption performance of the material over 10 cycles.

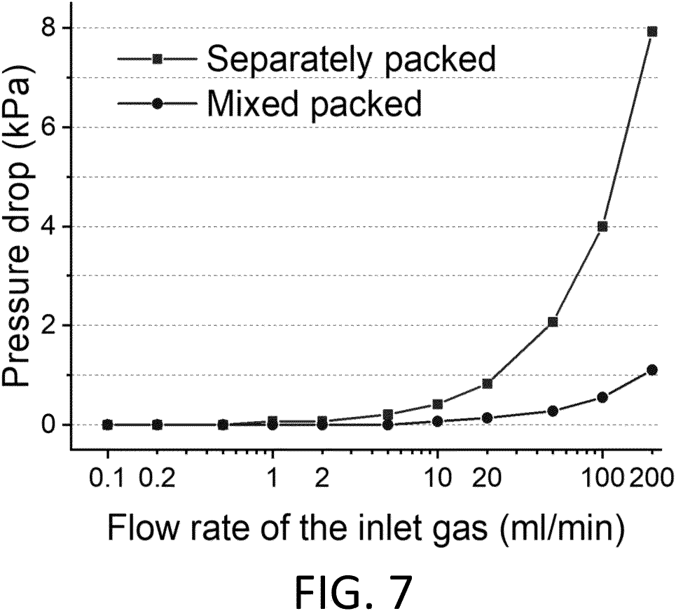

Use of small particles in a packed column can cause a large column pressure drop that may reduce process performance. To mitigate the potential risk of a high pressure drop, the sorbent material was mixed with inert packing material with a larger particle size. The particle mixture was then loaded into the sorption column. FIG. 7 shows a comparison between this mixed packing method and the conventional separate packing method in which the inert material is packed on the sides and the sorbent material is packed in the center of the column. The mixed packing method reduces the pressure drop to almost one-eighth that of the separate packing method as shown in FIG. 7.

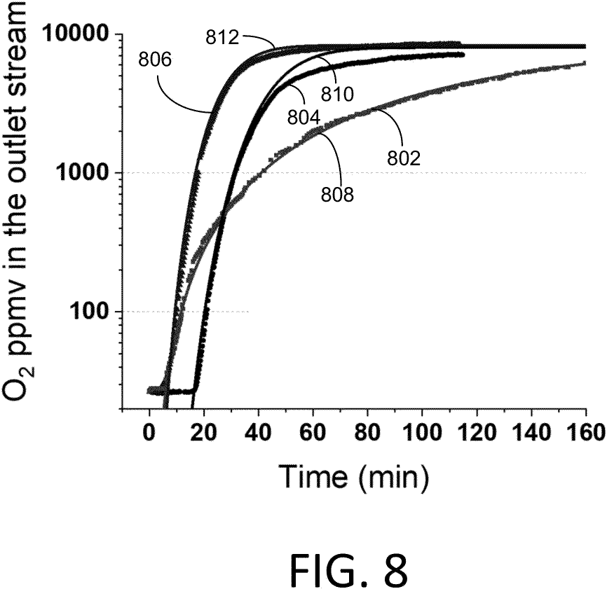

Oxygen sorption breakthrough experiments were performed with YBC114 to determine the processed input gas oxygen concentration profile of sorption and desorption. A breakthrough occurs when the processed input gas oxygen concentration has a significant increase during the sorption step. By definition a breakthrough occurred when the outlet oxygen concentration reached 100 ppmv. The shape of the breakthrough curve contains information about the mass transfer properties of the sorption system. The working capacity of the sorbent material for a dynamic sorption process was also determined by integrating the breakthrough data. FIG. 8 shows the oxygen sorption breakthrough curves at 275° C. (802), 300° C. (804) , and 325° C. (806) with 1% oxygen mixture. YBC114 produced an ISG for about 10 minutes at 275° C. and 325° C., and 20 minutes at 300° C. A favorable sorption temperature was determined to be 300° C. since it has a long duration for producing an ISG. From the previous TGA characterizations, YBC114 has a larger oxygen sorption capacity at 275° C. and a faster oxygen sorption rate at 300° C. Combined capacity and kinetics account for the improved process performance at 300° C. Breakthrough simulations were performed with the isotherm data obtained from TGA characterizations and inferred mass transfer coefficients from sorption breakthrough measurements. The simulated results for 275° C. (808), 300° C. (810), and 325° C. (812) are plotted in FIG. 8.

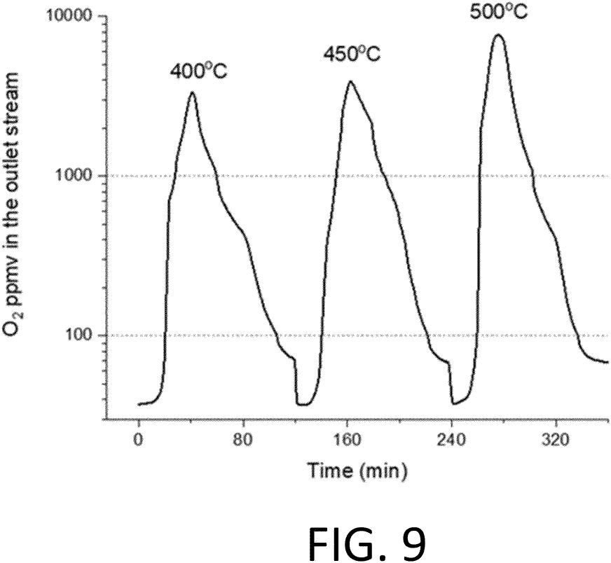

Three consecutive sorption-desorption cycles were performed with identical sorption conditions but different desorption temperatures from 400° C. to 500° C. As shown in FIG. 9, the desorption profile at 500° C. has a narrower and higher peak than the first two cycles, which indicates faster desorption rates. Desorption kinetics is a factor in the overall efficiency of producing ISG with TSA cycles, since fast desorption shortens the minimum time required for desorption in each cycle. 500° C. is therefore an advantageous desorption temperature in this scenario.

To fully assess the effect of other operating variables except for temperatures (such as pO2 and flow rate) on process performance, a series of breakthrough experiments were performed with varying oxygen concentrations or flow rates. The sorption and desorption temperatures are fixed at 300° C. and 500° C., respectively. Table 2 summarizes oxygen sorption performance at different pO2s or flow rates. The static capacity was measured in previous TGA characterizations, and the dynamic capacity was obtained from the oxygen sorption breakthrough experiments. The mass transfer coefficients were estimated for different pO2s with a linear driving force (LDF) model that typically has a good kinetics prediction of cyclic sorption systems. The equation of the LDF model is shown as follows:

$$\frac{\partial q}{\partial t} = k \left({q}_{s a t} - q\right)$$

where k is a lumped mass transfer coefficient that includes all the mass transfer mechanisms during fixed-bed sorption, and qₛₐₜ is the saturation uptake amount that is accessible from the isotherm model. As evident in the table, both capacities and mass transfer coefficients increase with pO2, while the breakthrough time decreases with pO2. As for the effect of flow rate, the sorption capacity inferred from breakthrough data at different flow rates are close, and all of them are less than the static oxygen capacity, which should be expected due to the existence of a mass transfer zone in the fixed bed. The breakthrough time and pressure drop also show reasonable correlations with the flow rates.

TABLE 2

Effect of pO2 (flow rate=100ml/min)

| O₂ conc. (%) | Static O₂ capacity (mol O₂/mol YBC114) | Dynamic O₂ capacity (mol O₂/mol YBC 114) | Breakthrough time (min) | Mass transfer coefficient (⅟s) |
|---|---|---|---|---|
| 1 | 0.075 | 0.055 | 42 | 0.02 |
| 5 | 0.32 | 0.24 | 35 | 0.17 |
| 10 | 0.48 | 0.35 | 24 | 0.25 |
| 30 | 0.85 | 0.46 | 11 | 0.44 |

Effect of flow rate (O₂ concentration = 10%)

| | | | | |
|---|---|---|---|---|
| Flow rate (ml/min) | Static O₂ capacity (mol O₂/mol YBC114) | Dynamic O₂ capacity (mol O₂/mol YBC114) | Breakthrough time (min) | Pressure drop (kPa) |
| 50 | 0.048 | 0.34 | 50 | 4.2 |
| 100 | | 0.35 | 23 | 9.4 |
| 200 | | 0.37 | 11 | 20.1 |

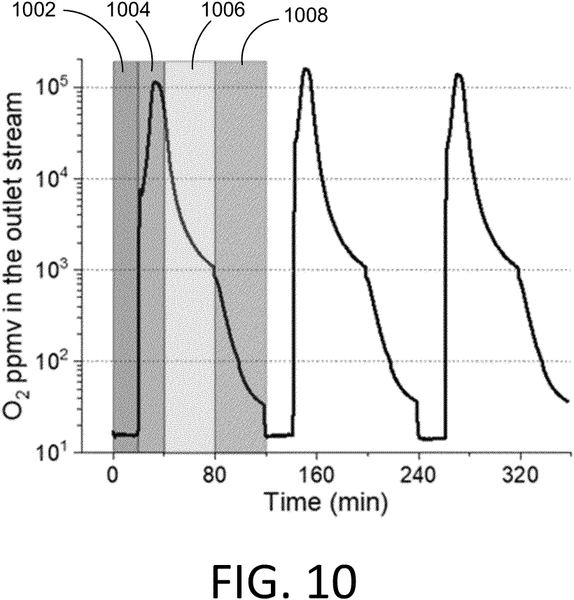

To analyze the performance of the oxygen separation unit with YBC114, a TSA operation was performed with the same setup used in the breakthrough experiments. In this process, the sorption bed was first regenerated with N₂ at 500° C. for 24 hours, to remove the initial adsorbed oxygen content in the particles. The temperature was then cooled to 275° C. for sorption, and the flow switched to a mixture of N₂ and O₂ with a pO2 of 10 kPa (i.e., 10% O₂). For the next cycle, the TSA was repeated between 300° C. and 500° C. for sorption and desorption. FIG. 10 shows the oxygen concentration profile for the first three cycles. Each cycle took two hours, including 20 minutes sorption (1002), 20 minutes heating (1004), 40 minutes desorption (1006), and 40 minutes cooling (1008). A key parameter is the duration for producing an ISG that has an oxygen concentration lower than 100 ppmv in the sorption step in each cycle. As evident in the plot, the O₂ concentration during the whole sorption step during the each of the three cycles (minima in the plot) is less than 100 ppmv, without an obvious increase from cycle to cycle. The TSA results are consistent with previous breakthrough measurements.

Process simulations were performed to simulate the TSA operation between 300° C. and 500° C. with an input gas mixture containing 1% oxygen. The simulation model was based on the isotherm data obtained from TGA characterizations and mass transfer coefficients inferred from sorption breakthrough measurements. The TSA process was simulated for 20 cycles to verify if it reached a cyclic steady state (CSS). As seen from F IG. 11, the oxygen concentration profile was consistent from cycle to cycle. The peak value of each cyclic oxygen concentration curve decreases from cycle to cycle, and the rate of decrease gradually levels off. For example, the decreasing rate during the first 5 cycles is in a range of 1 -2%. For the last five cycles (i.e., cycles 16-20), the rate of decrease is reduced to less than 0.2%, where the TSA was considered to have reached CSS.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. An oxygen separation method comprising:
a) contacting a sorbent with a first gas stream;
b) adsorbing oxygen in the first gas stream with the sorbent, wherein the sorbent is selective for oxygen and the adsorbing occurs at an adsorbing temperature between 275° C. and 325° C.,
c) heating the sorbent to a desorbing temperature greater than 400° C.; and
d) desorbing a majority of the oxygen to yield a second gas stream, wherein a difference between the desorbing temperature and the adsorbing temperature is less than 400° C.

2. The method of claim 1, further comprising cooling the sorbent to a temperature between 275° C. and 325° C. after desorbing the majority of the oxygen.

3. The method of claim 2, further comprising repeating a) through d) after cooling the sorbent.

4. The method of claim 1, wherein contacting the sorbent with the first gas stream comprises flowing the first gas stream in a first direction through the sorbent.

5. The method of claim 1, wherein desorbing the majority of oxygen comprises subjecting the sorbent to a vacuum.

6. The method of claim 1, wherein desorbing the majority of oxygen comprises contacting the sorbent with a purge gas.

7. The method of claim 6, wherein the purge gas comprises carbon dioxide, steam, or flue gas.

8. The method of claim 7, wherein the flue gas is recycled flue gas.

9. The method of claim 6, wherein desorbing the majority of the oxygen comprises flowing the purge gas in a second direction through the sorbent.

10. The method of claim 9, wherein the second direction is opposite the first direction.

11. The method of claim 1, wherein desorbing the majority of the oxygen comprises regenerating the sorbent.

12. The method of claim 1, further comprising providing the second gas stream to an energy storage reactor.

13. The method of claim 1, wherein adsorbing oxygen in the first gas stream further comprises increasing or decreasing a pressure of the first gas stream.

14. The method of claim 1, further comprising contacting an additional sorbent with an additional gas stream during b), c), or d).

15. An oxygen separation system comprising:
a sorption bed comprising a sorbent, wherein the sorbent is oxygen-selective;
a heater configured to heat the sorption bed;
an oxygen analyzer;
a first conduit configured to provide an input gas to a sorption bed;
a second conduit configured to provide processed input gas from the sorption bed to the oxygen analyzer,
a third conduit configured to provide a purge gas to the sorption bed; and
a fourth conduit configured to provide processed purge gas to the oxygen analyzer,
wherein the first conduit and the third conduit are configured to flow the input gas and the purge gas flow in opposite directions through the sorption bed.

16. The system of claim 15, wherein the sorption bed further comprises an inert packing material.

17. The system of claim 16, wherein a particle size of the inert packing material exceeds a particle size of the sorbent.

18. The system of claim 15, wherein the sorbent comprises YBaCo₄O_{7=δ.}

19. The system of claim 15, wherein the sorption bed is a fixed bed.

20. The system of claim 15, further comprising an additional sorption bed configured to operate in parallel to the sorption bed.

21. An energy storage reactor comprising the oxygen separation system of claim 15.
